(19) United States
(12) Patent Application Publication
(10) Pub. No.: US 2023/0191538 A1
(43) Pub. Date: Jun. 22, 2023

(54) LASER PROCESSING DEVICE, LASER PROCESSING METHOD, AND TRANSMISSION INHIBITION LIQUID

(71) Applicant: KOMATSU INDUSTRIES CORPORATION, Kanazawa-shi, Ishikawa (JP)

(72) Inventors: Yoshihiro YAMAGUCHI, Kanazawa-shi, Ishikawa (JP); Shigeru NOZAKI, Kanazawa-shi, Ishikawa (JP); Kyohei OKAMOTO, Kanazawa-shi, Ishikawa (JP); Nobuhiro TAKATA, Kanazawa-shi, Ishikawa (JP); Keita KONDOU, Kanazawa-shi, Ishikawa (JP)

(73) Assignee: KOMATSU INDUSTRIES CORPORATION, Kanazawa-shi, Ishikawa (JP)

(21) Appl. No.: 17/928,675

(22) PCT Filed: May 21, 2021
(86) PCT No.: PCT/JP2021/019283

§ 371 Date: Nov. 30, 2022

(30) Foreign Application Priority Data
Jul. 10, 2020 (JP) 2020-118893

(51) Int. Cl. B23K 26/70; B23K 26/10

(52) U.S. Cl. CPC B23K 26/706; B23K 26/10

(57) ABSTRACT

A laser processing device is a device that processes a workpiece using a laser beam, and includes a cutting pallet and a container. The cutting pallet includes a placement unit that supports a lower surface of the workpiece. The container supports the cutting pallet and is capable of storing a transmission inhibition liquid inhibiting transmission of light having a wavelength greater than or equal to 0.7 µm and less than or equal to 10 µm up to a height position of the placement unit.

### TECHNICAL FIELD

The present disclosure relates to a laser processing device, a laser processing method, and a transmission inhibition liquid.

### BACKGROUND ART

Examples of the laser processing device using a fiber laser include a machine room-type fiber laser processing device and a gantry-type fiber laser processing device. A machine room-type fiber laser processing device is used when a workpiece is relatively small. In this type of processing device, an entire cutting table is covered with a machine room such that a laser beam does not leak to an outside of the device.

The gantry-type fiber laser processing device is used when the workpiece is relatively large. In this type of processing device, because the entire cutting table cannot be covered, a periphery of a laser head is covered with a cover such that the laser beam does not leak to the outside of the device.

For example, the gantry-type fiber laser processing device is disclosed in Japanese Patent No. 5940582 (PTL 1). In PTL 1, a light shielding member is attached to a lower end side of each of a laser nozzle-side cover body and a garter-side cover body. The light shielding member prevents the leakage of the laser beam from a gap between a lower end of each of the laser nozzle-side cover body and the garter-side cover body and an upper surface of a surface plate.

For example, a device using water in the laser processing device is disclosed in Japanese Patent Laying-Open No. 8-132270 (PTL 2) and Japanese Patent Laying-Open No. 62-168692 (PTL 3).

In PTL 2, the laser processing is performed in a state where a lower portion of the workpiece is immersed in cooling water in a water tank of a machining table. Thus, the entire workpiece can be cooled from below, and stable processing can be performed.

In PTL 3, the workpiece supported by a sword pin is subjected to the laser processing while water is put in a mounting box of the sword pin. The water in the water tank cools the workpiece during laser cutting to prevent scattering of dust.

### Citation List

### Patent Literatures

PTL 1: Japanese Patent No. 5940582
PTL 2: Japanese Patent Laying-Open No. 8-132270
PTL 3: Japanese Patent Laying-Open No. 62-168692

### SUMMARY OF INVENTION

### Technical Problem

In the laser processing device described in PTL 1, there is a risk that the laser beam penetrates the workpiece to leak to the outside of the device by being reflected in the cutting table below the workpiece. In order to prevent the leakage of the laser beam, a cutting table-side light shielding member is required to be installed below the workpiece. For this reason, a structure of the laser processing device becomes complicated.

Furthermore, in PTL 1, the cutting table-side light shielding member disposed below the workpiece is scraped off little by little by the laser beam. For this reason, light shielding becomes not perfect as time elapses, and the laser beam leaks to the outside of the device.

Furthermore, in PTLs 2 and 3, the water in the water tank is used for the purpose of cooling the workpiece or preventing the scattering of the dust, and the light shielding of the laser beam is not considered.

An object of the present disclosure is to provide a laser processing device, a laser processing method, and a transmission inhibition liquid capable of preventing the leakage of the laser beam to the outside with a simple device construction.

### Solution to Problem

As a result of intensive studies, the inventors have made the present disclosure by focusing on an idea that a transmission inhibition liquid inhibiting transmission of laser beam is used to prevent leakage of the laser beam, which does not exist heretofore.

A laser processing device of the present disclosure is a laser processing device that processes a workpiece using a laser beam, and includes a support member and a container. The support member includes a placement unit supporting a lower surface of the workpiece. The container is capable of storing a transmission inhibition liquid inhibiting transmission of the laser beam up to a height position of the placement unit.

The term “the transmission inhibition liquid is capable of being stored up to the height position of the placement unit” means that the transmission inhibition liquid can be stored up to at least the height position of the placement unit, and includes that the transmission inhibition liquid can be stored up to a position above the height position of the placement unit.

A laser processing method of the present disclosure is a laser processing method for performing laser processing on a workpiece using a laser processing device, and includes the following steps.

A transmission inhibition liquid inhibiting transmission of light having a wavelength greater than or equal to 0.7 µm and less than or equal to 10 µm is stored in the container. The workpiece is placed on the container. The workpiece is processed using a laser beam in a state where the transmission inhibition liquid is stored under the workpiece while the laser beam penetrating the workpiece enters the transmission inhibition liquid.

The transmission inhibition liquid of the present disclosure is a transmission inhibition liquid used for laser processing, and inhibits transmission of light having a wavelength greater than or equal to 0.7 µm and less than or equal to 10 µm.

Another laser processing device of the present disclosure is a laser processing device that processes a workpiece using a laser beam, and includes a support member and a container. The support member includes a placement unit supporting a lower surface of the workpiece. The container is capable of storing a transmission inhibition liquid inhibiting transmission of light having a wavelength greater than or equal to 0.7 µm and less than or equal to 10 µm up to a height position of the placement unit.

### Advantageous Effects of Invention

According to the present disclosure, the laser processing device, the laser processing method, and the transmission inhibition liquid capable of preventing the leakage of the laser beam to the outside can be implemented with the simple device construction.

### BRIEF DESCRIPTION OF DRAWINGS

FIG. 1 is a perspective view illustrating a configuration of a laser processing device according to an embodiment.

FIG. 2 is a sectional perspective view illustrating an internal configuration of a container used in the laser processing device of FIG. 1.

FIG. 3 is a sectional view illustrating a configuration of a laser head used in the laser processing device of FIG. 1.

FIG. 4 is a sectional view illustrating a configuration of a light shielding cover used in the laser processing device of FIG. 1.

FIG. 5 is a sectional view illustrating a configuration of a liquid level adjustment mechanism used in the laser processing device of FIG. 1.

FIG. 6 is a perspective view illustrating a first process of a laser processing method of the embodiment.

FIG. 7 is a perspective view illustrating a second process of the laser processing method of the embodiment.

FIG. 8 is a perspective view illustrating a third process of the laser processing method of the embodiment.

FIG. 9 is a perspective view illustrating a fourth process of the laser processing method of the embodiment.

FIG. 10 is a perspective view illustrating a fifth process of the laser processing method of the embodiment.

FIG. 11 is a view illustrating a state of adjusting a liquid level of a transmission inhibition liquid in the container.

FIG. 12 is a view illustrating a state in which a workpiece is subjected to laser processing.

FIG. 13 is a view illustrating a state in which the workpiece or the like is taken out from the container after the laser processing of the workpiece.

FIG. 14 is a sectional view illustrating another configuration of a laser beam shielding member.

FIG. 15 is a view illustrating power density of a laser beam at a distance L from a processing point of the workpiece by the laser processing.

FIG. 16 is a view illustrating a thickness of a medium.

FIG. 17 is a view illustrating a relationship between the thickness of the medium and transmittance.

FIG. 18 is an enlarged view of a region R in FIG. 17.

FIG. 19 is a view illustrating winding of the transmission inhibition liquid into a laser irradiation unit during the laser processing.

FIG. 20 is a view illustrating a configuration of a device examining a relationship between the transmittance of the laser beam and a depth of liquid.

FIG. 21 is a view illustrating a relationship between intensity of the laser beam and the depth of the liquid when tap water is used.

FIG. 22 is a view illustrating the relationship between the intensity of the laser beam and the depth of the liquid when an aqueous solution obtained by adding India ink to tap water is used.

### DESCRIPTION OF EMBODIMENT

With reference to the drawings, an embodiment of the present disclosure will be described in detail below. In the specification and the drawings, the same components or corresponding components are denoted by the same reference numerals, and redundant description will not be repeated. In the drawings, the construction may be omitted or simplified for convenience of description.

### Construction of Laser Processing Device

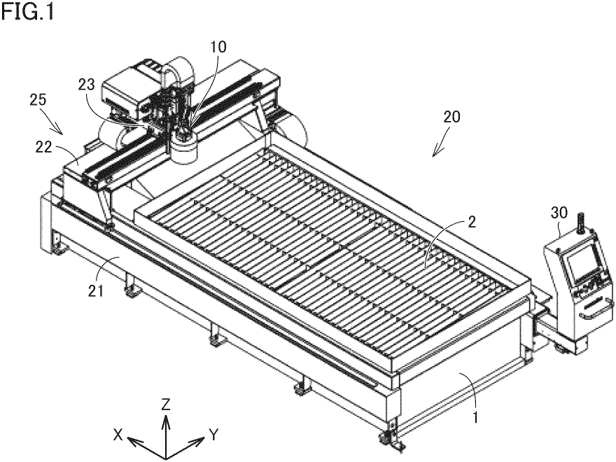

With reference to FIGS. 1 to 5, a construction of a laser processing device according to an embodiment will be described below.

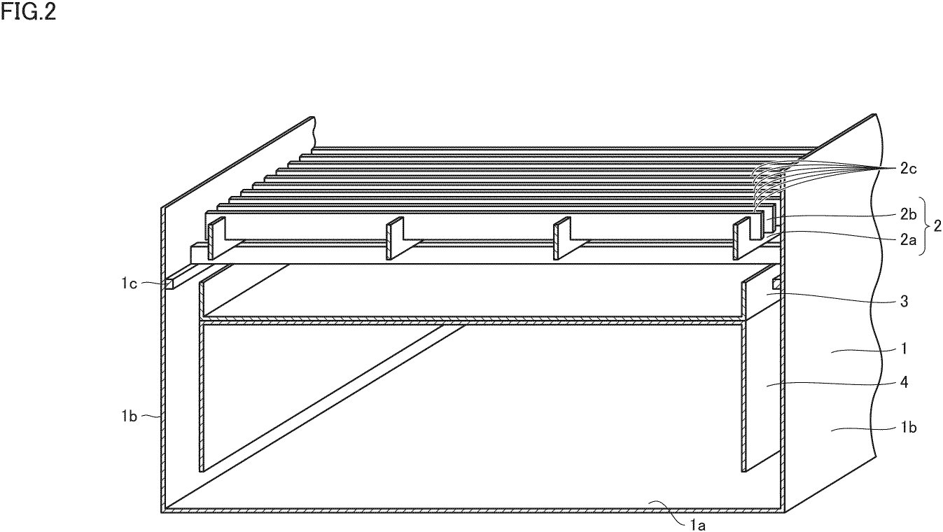

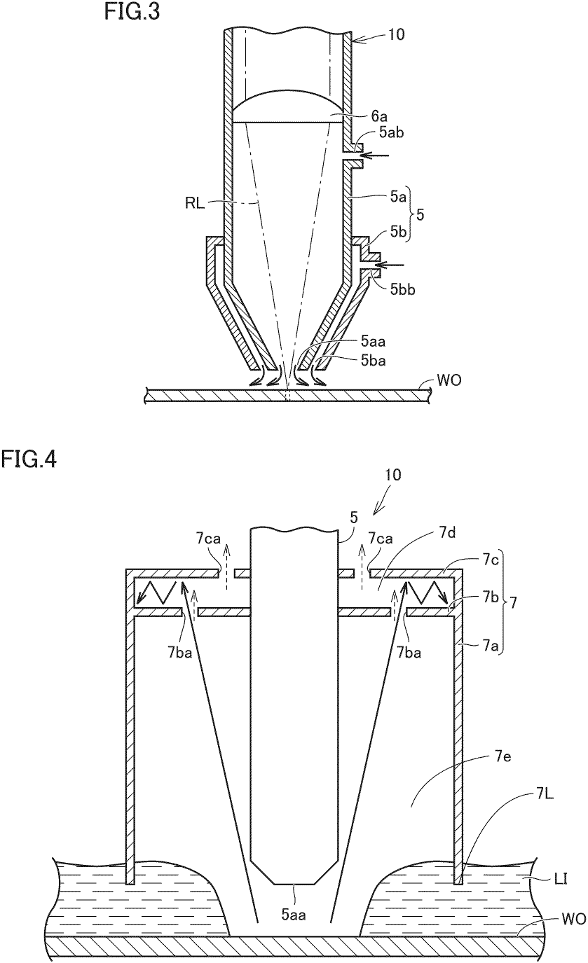

FIG. 1 is a perspective view illustrating the construction of the laser processing device of the embodiment. FIG. 2 is a sectional perspective view illustrating an internal construction of a container used in the laser processing device of FIG. 1. FIGS. 3, 4, and 5 are sectional views illustrating constructions of a laser head, a light shielding cover, and a liquid level adjustment mechanism used in the laser processing device of FIG. 1.

As illustrated in FIGS. 1 and 2, a laser processing device 20 of the embodiment mainly includes a container 1, a cutting pallet 2 (support member), a sludge tray 3, a liquid level adjustment tank 4, a laser head 10, a drive mechanism 25, and an operation panel 30.

As illustrated in FIG. 2, container 1 includes a rectangular bottom wall 1a and four side walls 1b rising from each of four sides of bottom wall 1a. Container 1 has a bottomed cylindrical shape with an open top. Container 1 includes an opening at an upper end and an internal space extending from the opening to an inside of container 1.

Container 1 is constructed to be able to store liquid in container 1. A pallet support 1c is provided in side wall 1b. Pallet support 1c protrudes laterally from a wall surface of side wall 1b toward the internal space of container 1.

Liquid level adjustment tank 4 is disposed in the internal space of container 1. Liquid level adjustment tank 4 has a box shape including an opening at a lower end. Through this opening, the internal space of liquid level adjustment tank 4 is connected to the internal space of container 1.

Liquid level adjustment tank 4 is constructed to be able to store gas in the internal space of liquid level adjustment tank 4. The gas can be supplied to or discharged from the internal space of liquid level adjustment tank 4. The liquid in liquid level adjustment tank 4 can be pushed out of liquid level adjustment tank 4 by supplying the gas into the internal space of liquid level adjustment tank 4. The liquid can be taken in from the outside to the inside of liquid level adjustment tank 4 by discharging the gas from the internal space of liquid level adjustment tank 4. Thus, the liquid level in container 1 can be adjusted.

Sludge tray 3 is disposed above liquid level adjustment tank 4. Sludge tray 3 has a box shape including the opening at the upper end. Sludge tray 3 can accumulate sludge generated when the workpiece is cut by the laser processing. The sludge generated during the laser processing falls from a workpiece WO (FIG. 5) and is accumulated inside sludge tray 3 through the opening at the upper end of sludge tray 3.

Cutting pallet 2 is supported by container 1 using pallet support 1c. Cutting pallet 2 is disposed in the interior space of container 1 and above sludge tray 3. Cutting pallet 2 includes a plurality of first support plates 2a and a plurality of second support plates 2b. The plurality of first support plates 2a and the plurality of second support plates 2b are assembled in a lattice shape by being arranged vertically and horizontally.

Cutting pallet 2 has a placement unit 2c that supports a lower surface of workpiece WO (FIG. 5). For example, placement unit 2c of cutting pallet 2 is constructed by an upper end of each of the plurality of second support plates 2b. Placement unit 2c is located at a position lower than the upper end of container 1 (the upper end of side wall 1b). The upper end of container 1 is located at a position higher than the upper surface of workpiece WO while workpiece WO is placed on placement unit 2c. Thus, when container 1 is filled with liquid while workpiece WO is placed on placement unit 2c, the liquid level of the liquid can be made higher than the upper surface of workpiece WO.

As illustrated in FIG. 1, drive mechanism 25 moves laser head 10 in the X-direction (longitudinal direction of container 1), the Y-direction (lateral direction of container 1), and the Z-direction (vertical direction). Drive mechanism 25 mainly includes a pair of left and right support bases 21, an X-direction movable base 22, a Y-direction movable base 23, and laser head 10.

The pair of left and right support bases 21 is disposed so as to sandwich container 1 in the Y-direction. The pair of left and right support bases 21 extends in the X-direction. X-direction movable base 22 is disposed across the pair of left and right support bases 21 by extending in the Y-direction. X-direction movable base 22 is driven in the X-direction along the support base 21 by an X-axis motor (not illustrated).

Y-direction movable base 23 is supported to be movable in the Y-direction with respect to X-direction movable base 22 by, for example, a rack and pinion mechanism. Y-direction movable base 23 is driven in the Y-direction by a Y-axis motor (not illustrated).

Laser head 10 is supported to be movable in the Z-direction with respect to Y-direction movable base 23 by, for example, a rack and pinion mechanism. Laser head 10 is driven in the Z-direction by a Z-axis motor (not illustrated).

Operation panel 30 receives input of a processing condition such as a plate thickness, a material, and a speed of workpiece WO. Operation panel 30 includes a display, a switch, and an alarm. The display displays an input screen of the machining condition, a screen indicating an operating status of laser processing device 20, and the like.

As illustrated in FIG. 3, laser head 10 mainly includes a head body 5 and a condensing lens 6a. Head body 5 includes a body 5a.

Body 5a has a hollow cylindrical shape. Condensing lens 6a is accommodated in body 5a. Condensing lens 6a condenses a laser beam RL on workpiece WO. Laser beam RL condensed by condensing lens 6a is emitted from a laser emission port 5aa (emission unit) of body 5a toward workpiece WO.

Laser beam RL used in laser processing device 20 of the embodiment has any wavelength of visible light, near-infrared light, mid-infrared light, and far-infrared light, and has a wavelength greater than or equal to 0.7 µm and less than or equal to 10 µm. For example, laser beam RL is a laser beam using fiber laser as a light source, and may be a laser beam using solid-state laser containing Yttrium Aluminum Garnet (YAG) as a light source. The fiber laser is a type of solid-state laser using an optical fiber as an amplification medium. In the fiber laser, a core located at the center of the optical fiber is doped with rare earth element Yb (ytterbium). Laser beam RL using the fiber laser as a light source is near-infrared light having a wavelength of about 1.06 µm. Running cost and maintenance cost of the fiber laser are lower than those of a carbon dioxide laser.

Body 5a includes a gas outlet 5aa (first outlet) and a gas supply unit 5ab. An assist gas is supplied from gas supply unit 5ab into body 5a. The assist gas supplied into body 5a is blown out from gas outlet 5aa toward workpiece WO. Gas outlet 5aa also serves as a laser emission port 5aa.

Head body 5 may further include an outer nozzle 5b. Outer nozzle 5b is attached to body 5a so as to surround the periphery of gas outlet 5aa of body 5a. A gap space is provided between the inner peripheral surface of outer nozzle 5b and the outer peripheral surface of body 5a.

Outer nozzle 5b includes a gas outlet 5ba (second outlet) and a gas supply unit 5bb. Each of gas outlet 5ba and gas supply unit 5bb is connected to the gap space. Gas outlet 5ba is disposed on the outer periphery of gas outlet 5aa, and has an annular shape.

The secondary gas (shielding gas) is supplied from gas supply unit 5bb to the gap space between body 5a and outer nozzle 5b. The secondary gas supplied into the gap space is blown out from gas outlet 5ba toward workpiece WO. Thus, the secondary gas is blown out from gas outlet 5ba onto the outer peripheral side of the assist gas blown out from gas outlet 5aa.

As described above, laser head 10 has gas outlets 5aa, 5ba. Gas outlets 5aa, 5ba may include gas outlet 5aa through which the assist gas is blown out and gas outlet 5ba through which the secondary gas is blown out. Gas outlet 5aa and gas outlet 5ba form a double nozzle structure.

As illustrated in FIG. 4, laser head 10 includes a light shielding cover 7. Light shielding cover 7 surrounds laser emission port 5aa (gas outlet 5aa). For example, light shielding cover 7 is made of a rubber sheet. Light shielding cover 7 includes a peripheral wall 7a, a first upper plate 7b, and a second upper plate 7c. Peripheral wall 7a has a cylindrical shape surrounding the outer periphery of head body 5.

First upper plate 7b and second upper plate 7c are attached to an upper portion of peripheral wall 7a. One or a plurality of first holes 7ba are made in first upper plate 7b. Second upper plate 7c is disposed on first upper plate 7b with a gap 7d interposed therebetween.

One or a plurality of second holes 7ca are made in second upper plate 7c. An internal space 7e of peripheral wall 7a located below first upper plate 7b is connected to the external space of light shielding cover 7 through first hole 7ba and second hole 7ca. As will be described later, even when liquid LI is stored up to a position higher than a lower end 7L of peripheral wall 7a of light shielding cover 7 during the laser processing, the gas in internal space 7e of light shielding cover 7 escapes to the outside of light shielding cover 7 through first hole 7ba and second hole 7ca by such the structure.

First hole 7ba, gap 7d, and second hole 7ca form a labyrinth structure with respect to the laser beam. Specifically, as indicated by a solid arrow in FIG. 4, second hole 7ca is not positioned ahead of the laser beam that is emitted from laser emission port 5aa of laser head 10 and reflected from workpiece WO, passes through first hole 7ba, and then travels linearly in gap 7d. For example, second hole 7ca is located on the inner peripheral side of first hole 7ba at a position in the radial direction centered on laser head 10.

The laser beam that passes through first hole 7ba and enters gap 7d is repeatedly reflected between first upper plate 7b and second upper plate 7c (by multiple reflection) and absorbed by light shielding cover 7. Thus, the laser beam does not leak from the inside of light shielding cover 7 to the outside.

As illustrated in FIG. 5, a supply pipe 36 is provided in order to supply liquid LI into container 1. A supply valve 31 is attached to supply pipe 36. The supply of liquid LI to the internal space of container 1 is started by opening supply valve 31, and the supply of liquid LI to the internal space of container 1 is stopped by closing supply valve 31.

A gas pipe 37 is connected to the liquid level adjustment tank 4 from the outside of container 1. A pressurizing valve 32 and a pressure reducing valve 33 are attached to gas pipe 37. The gas is supplied into liquid level adjustment tank 4 when pressurizing valve 32 is opened, and the supply of the gas into liquid level adjustment tank 4 is stopped when the pressurizing valve 32 is closed. The gas in liquid level adjustment tank 4 is discharged to the outside by opening pressure reducing valve 33, and the discharge of the gas from liquid level adjustment tank 4 is stopped by closing pressure reducing valve 33. Liquid level adjustment tank 4, gas pipe 37, pressurizing valve 32, and pressure reducing valve 33 are included in the liquid level adjustment mechanism. As described later, the liquid level adjustment mechanism adjusts the liquid level of a transmission inhibition liquid LI in container 1 based on the detection result of a liquid level detection sensor 41.

An overflow pipe 38 is attached to container 1. When the liquid level in container 1 becomes greater than or equal to a predetermined liquid level, the liquid in container 1 is discharged to a liquid storage tank 35 through overflow pipe 38. Liquid storage tank 35 is disposed outside container 1.

A liquid discharge pipe 39 is attached to container 1. A discharge valve 34 is attached to liquid discharge pipe 39. Liquid LI in container 1 is discharged to liquid storage tank 35 by opening discharge valve 34, and the discharge of liquid LI from container 1 is stopped by closing discharge valve 34.

Container 1 is constructed to be capable of storing liquid LI at least up to a height position HL of placement unit 2c. Container 1 is capable of storing liquid LI up to a position higher than the upper surface of workpiece WO placed on placement unit 2c. Furthermore, container 1 is capable of storing liquid LI up to a position higher than the lower end of peripheral wall 7a of light shielding cover 7 during the laser processing.

Liquid LI stored in container 1 is transmission inhibition liquid LI that inhibits transmission of the laser beam. Transmission inhibition liquid LI absorbs the light to inhibit the transmission of the laser beam. For example, transmission inhibition liquid LI inhibits the transmission of the light having a wavelength greater than or equal to 0.7 µm and less than or equal to 10 µm.

For example, the transmittance of the light in a wavelength range greater than or equal to 0.7 µm and less than or equal to 10 µm in transmission inhibition liquid LI is less than or equal to 10%/cm. For example, the transmittance of the light in the wavelength range greater than or equal to 0.7 µm and less than or equal to 10 µm in transmission inhibition liquid LI is preferably less than or equal to 5%/cm. For example, the transmittance of the light in the wavelength range greater than or equal to 0.7 µm and less than or equal to 10 µm in transmission inhibition liquid LI is more preferably less than or equal to 3%/cm.

Transmission inhibition liquid LI contains an additive that absorbs or scatters the light in the wavelength range greater than or equal to 0.7 µm and less than or equal to 10 µm in order to inhibit the transmission of the light in the wavelength range greater than or equal to 0.7 µm and less than or equal to 10 µm. For example, this additive contains carbon. The additive is preferably black. For example, transmission inhibition liquid LI is an aqueous solution obtained by adding carbon to water. For example, transmission inhibition liquid LI is an aqueous solution obtained by adding 0.1 vol% of India ink to water. The water in the present specification may be tap water or pure water. The India ink is obtained by dispersing carbon black (carbon) in an aqueous solution of glue or another water-soluble resin, and a mixing ratio of the carbon black is 4.0 wt% to 20.0 wt%, preferably 5.0 wt% to 10.0 wt% with respect to the total amount. For example, the India ink is commercially available “Kuretake concentrated ink Bokuteki BA7-18”.

Transmission inhibition liquid LI preferably contains a rust inhibitor. The rust inhibitor is a corrosion inhibitor that inhibits corrosion of a steel material or the like. For example, the rust inhibitor is water-soluble. For example, a precipitated film type inhibitor, a passive type inhibitor, or a deoxygenated type inhibitor may be used as the rust inhibitor.

Laser processing device 20 further includes a liquid level detection sensor 41, a transmittance detection sensor 42, a controller 50, an alarm 51, and a processing start switch 52. Liquid level detection sensor 41 detects the liquid level of transmission inhibition liquid LI stored in container 1. Transmittance detection sensor 42 detects the transmittance of transmission inhibition liquid LI stored in container 1.

Alarm 51 gives a notification of the state of laser processing device 20 to the outside by display, sound, or the like. Alarm 51 may be a warning light, a display, or a speaker provided on operation panel 30 (FIG. 1). Processing start switch 52 issues an instruction to start the laser processing by laser processing device 20 by an external operation. Processing start switch 52 may be provided on operation panel 30. Processing start switch 52 may be a touch panel provided on operation panel 30.

Controller 50 controls to open and close supply valve 31, pressurizing valve 32, pressure reducing valve 33, and discharge valve 34. Controller 50 controls movement of laser head 10 in the X-, Y-, and Z-directions, laser irradiation from laser head 10, and the like. Controller 50 controls the notification of alarm 51.

Controller 50 receives a signal indicating the liquid level of transmission inhibition liquid LI in container 1 detected by liquid level detection sensor 41. Controller 50 receives a signal indicating the transmittance of transmission inhibition liquid LI detected by transmittance detection sensor 42. Controller 50 receives a signal indicating a processing start instruction by processing start switch 52.

Controller 50 controls opening and closing of pressurizing valve 32 or pressure reducing valve 33 based on the detection result of liquid level detection sensor 41. Thus, an amount of gas stored in liquid level adjustment tank 4 is adjusted, and the liquid level of transmission inhibition liquid LI stored in container 1 is adjusted. In this manner, controller 50 controls the opening and closing of pressurizing valve 32 or pressure reducing valve 33 such that the liquid level adjustment mechanism (liquid level adjustment tank 4, gas pipe 37, pressurizing valve 32, and pressure reducing valve 33) adjusts the liquid level of transmission inhibition liquid LI stored in container 1.

Controller 50 issues a control instruction for at least one of the notification by alarm 51 and the laser processing operation based on the detection result of transmittance detection sensor 42. When the transmittance of transmission inhibition liquid LI detected by transmittance detection sensor 42 is greater than a predetermined value (for example, 10%/cm, 5%/cm, or 3%/cm), controller 50 issues the control instruction to execute the notification by alarm 51 or the control instruction to stop execution of the laser processing (or not to start the laser processing). For example, the notification by alarm 51 is performed by display or sound.

On the other hand, when the transmittance of transmission inhibition liquid LI detected by transmittance detection sensor 42 is less than or equal to a predetermined value (for example, 10%/cm, 5%/cm, or 3%/cm), controller 50 issues the control instruction not to execute the notification by alarm 51 but to execute the execution of the laser processing.

For example, controller 50 is a processor, and may be a central processing unit (CPU).

### Laser Processing Method

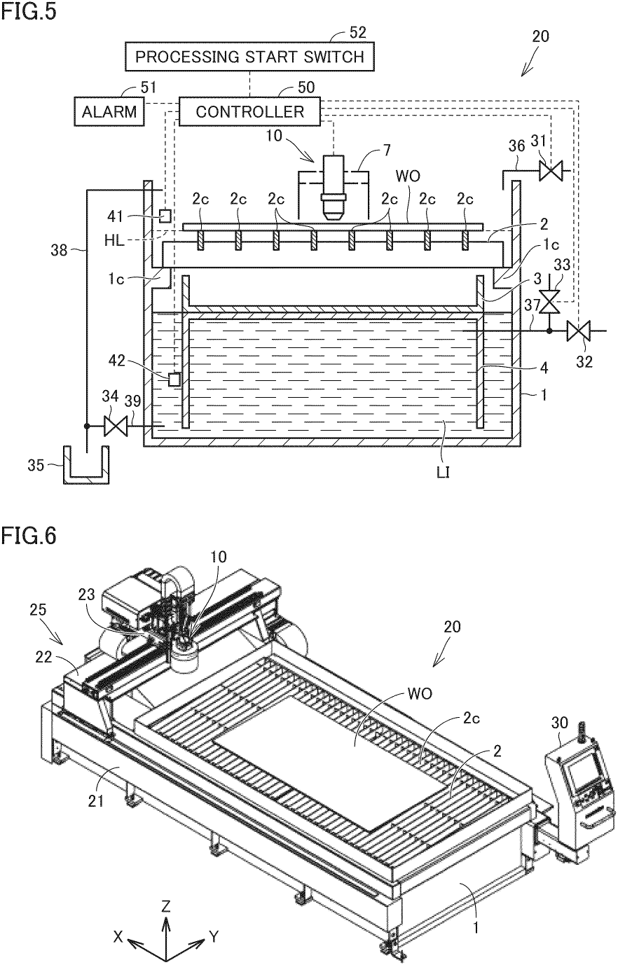

With reference to FIGS. 6 to 13, a laser processing method using the laser processing device of the embodiment will be described below.

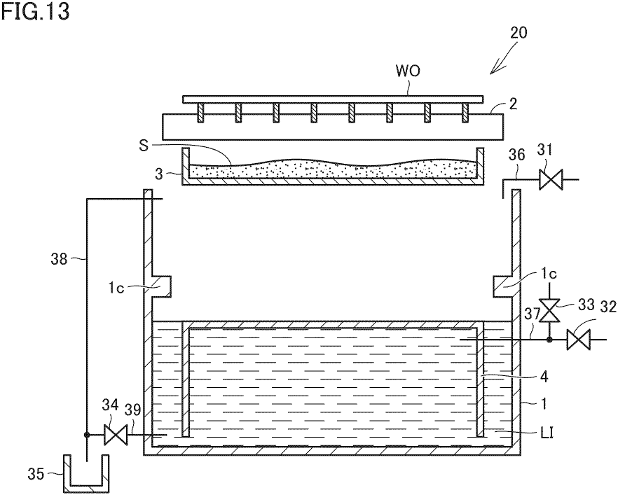

FIGS. 6 to 10 are perspective views illustrating the laser processing method of the embodiment in order of processes. FIG. 11 is a view illustrating a state of adjusting the liquid level of the transmission inhibition liquid in the container. FIG. 12 is a view illustrating a state in which the workpiece is subjected to the laser processing. FIG. 13 is a view illustrating a state in which the workpiece or the like is taken out from the container after the laser processing of the workpiece.

As illustrated in FIG. 6, transmission inhibition liquid LI is supplied into container 1 of laser processing device 20. At this point, controller 50 in FIG. 5 controls to open supply valve 31. Thus, transmission inhibition liquid LI is supplied from supply pipe 36 into container 1. At this point, controller 50 detects the liquid level of transmission inhibition liquid LI in container 1 using liquid level detection sensor 41. When determining that the liquid level of transmission inhibition liquid LI in container 1 reaches a desired liquid level based on the detection result of liquid level detection sensor 41, controller 50 controls supply valve 31 to be closed. At this point, for example, transmission inhibition liquid LI is supplied to the position lower than the height position of placement unit 2c of cutting pallet 2.

As illustrated in FIG. 6, workpiece WO is carried into laser processing device 20. Workpiece WO is disposed on placement unit 2c of cutting pallet 2. For example, workpiece WO is a steel material. In this state, the laser processing operation by laser processing device 20 is started.

As illustrated in FIG. 5, for example, the laser processing operation in laser processing device 20 is started by operating processing start switch 52. Upon receiving the signal to start the laser processing operation from processing start switch 52, controller 50 controls transmittance detection sensor 42 to detect the transmittance of transmission inhibition liquid LI in container 1.

Controller 50 determines whether the transmittance of transmission inhibition liquid LI detected by transmittance detection sensor 42 is less than or equal to a predetermined transmittance (for example, 10%/cm, 5%/cm, or 3%/cm). When the transmittance of transmission inhibition liquid LI is greater than the predetermined transmittance, controller 50 controls laser processing device 20 not to start the laser processing operation or to stop the performance of the laser processing operation. When the transmittance of transmission inhibition liquid LI is greater than the predetermined transmittance, controller 50 controls alarm 51 to notify that the transmittance of transmission inhibition liquid LI is greater than the predetermined transmittance by the display or the sound.

On the other hand, when the transmittance of transmission inhibition liquid LI is less than or equal to the predetermined transmittance, controller 50 controls laser processing device 20 so as to start the laser processing operation by laser processing device 20 or not to stop the performance of the laser processing operation.

When the laser processing operation is started, controller 50 adjusts the liquid level of transmission inhibition liquid LI stored in container 1 based on the detection result of liquid level detection sensor 41. Specifically, for example, controller 50 controls pressurizing valve 32 to open. Thus, the gas is supplied into liquid level adjustment tank 4, and the liquid level of transmission inhibition liquid LI stored in container 1 is adjusted to be high.

As illustrated in FIG. 11, the liquid level of transmission inhibition liquid LI is adjusted to the position higher than the upper surface of workpiece WO by adjusting the liquid level of transmission inhibition liquid LI. As a result, entire workpiece WO sinks (is immersed) in transmission inhibition liquid LI.

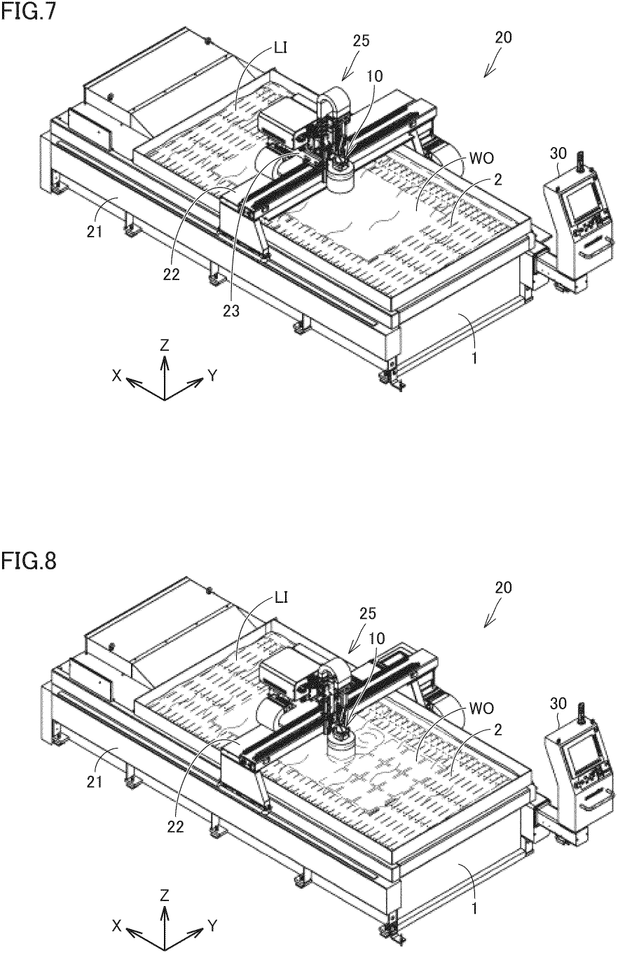

As illustrated in FIG. 7, in this state, laser head 10 moves to the start position of the laser processing. The movement of laser head 10 is controlled by controller 50 (FIG. 5). Specifically, X-direction movable base 22 moves in the X-direction with respect to the pair of left and right support bases 21. Y-direction movable base 23 moves in the Y-direction with respect to X-direction movable base 22. Laser head 10 moves in the Z-direction with respect to Y-direction movable base 23.

As illustrated in FIG. 8, the laser processing by laser processing device 20 is started. During the laser processing, workpiece WO is irradiated with the laser beam from laser head 10. Furthermore, the assist gas is blown from laser head 10 toward workpiece WO.

As illustrated in FIG. 12, during the laser processing, the liquid level of transmission inhibition liquid LI is adjusted to be higher than lower end 7L of light shielding cover 7. Thus, lower end 7L of light shielding cover 7 is located between the liquid level of transmission inhibition liquid LI and the upper surface of workpiece WO.

The assist gas is blown from laser head 10 toward workpiece WO. Transmission inhibition liquid LI is pushed away at a processing point of workpiece WO by blowing force of the assist gas. Thus, the upper surface of workpiece WO is exposed from transmission inhibition liquid LI at the processing point of workpiece WO.

The upper surface of workpiece WO exposed from transmission inhibition liquid LI is irradiated with the laser beam. Workpiece WO is processed by the irradiation with the laser beam. Thus, for example, workpiece WO is cut. The laser beam that penetrates workpiece WO by cutting workpiece WO enters transmission inhibition liquid LI stored below workpiece WO.

The assist gas blown out from laser head 10 passes from the inside to the outside of light shielding cover 7 through first hole 7ba of first upper plate 7b and second hole 7ca of second upper plate 7c. For this reason, an increase in the pressure of the gas inside light shielding cover 7 due to the blowing of the assist gas is inhibited.

Second hole 7ca of second upper plate 7c is disposed on second upper plate 7c while avoiding the position ahead of the laser beam that is reflected from workpiece WO, passes through first hole 7ba, and travels linearly in gap 7d. For this reason, the laser beam reflected from workpiece WO is prevented from leaking from the inside of light shielding cover 7 to the outside. Accordingly, the laser beam that passes through first hole 7ba and enters gap 7d is repeatedly reflected between first upper plate 7b and second upper plate 7c (by multiple reflection) to be absorbed by light shielding cover 7.

As illustrated in FIG. 11, sludge S generated when workpiece WO is cut by the laser processing sinks into transmission inhibition liquid LI and accumulates in sludge tray 3. For example, sludge S is iron oxide particles in which molten iron is hardened. As described above, the laser processing is performed while workpiece WO is immersed in transmission inhibition liquid LI, whereby scattering of sludge S generated during the processing to the surroundings is prevented.

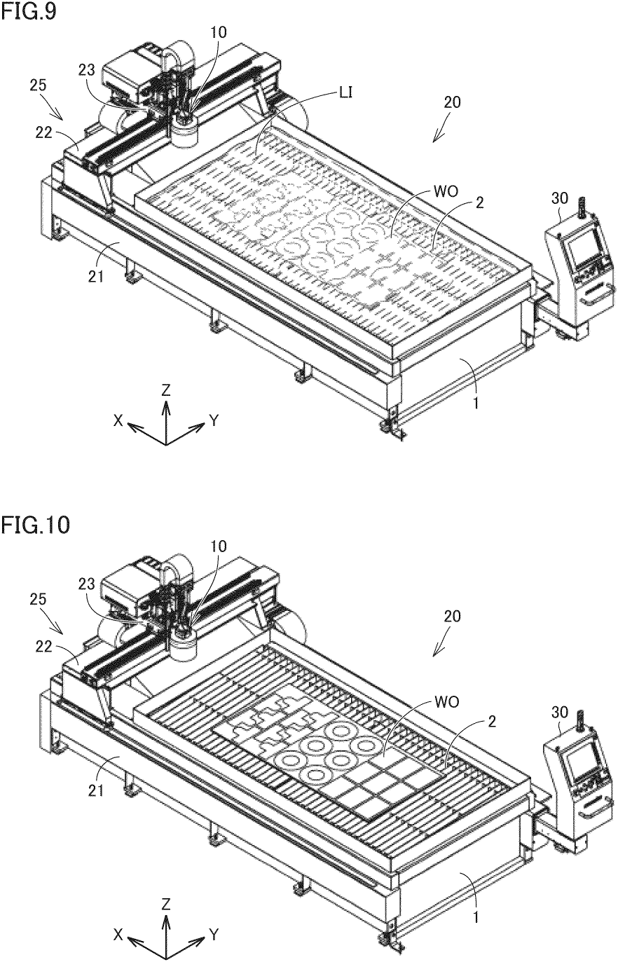

As illustrated in FIG. 9, when the laser processing is completed, controller 50 (FIG. 5) controls laser head 10 to move to an initial position. Specifically, X-direction movable base 22 moves in the X-direction with respect to the pair of left and right support bases 21. Y-direction movable base 23 moves in the Y-direction with respect to X-direction movable base 22. Laser head 10 moves in the Z-direction with respect to Y-direction movable base 23.

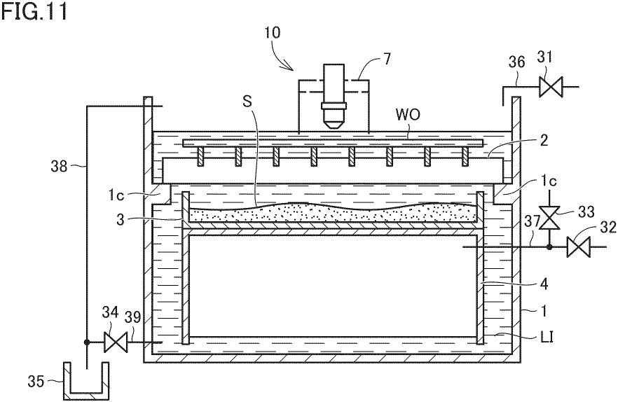

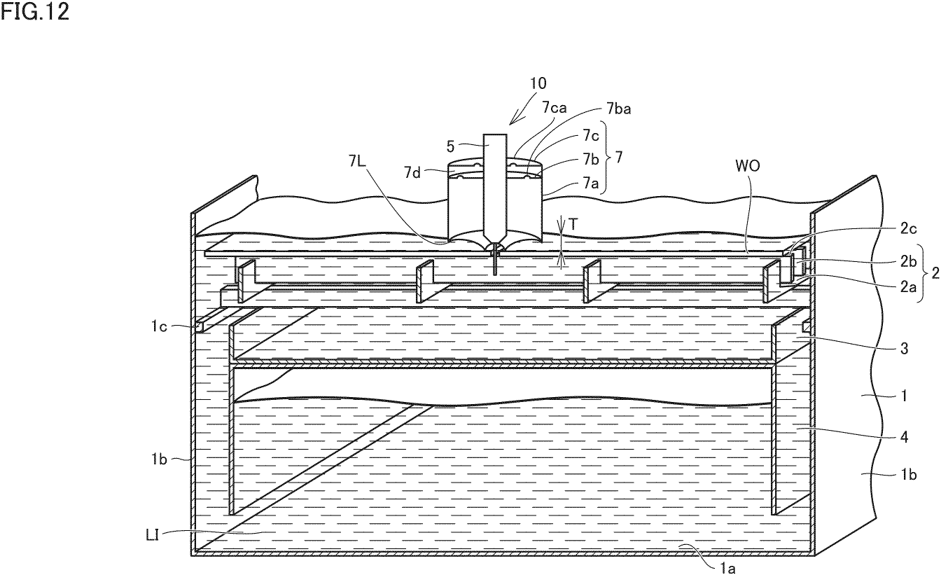

As illustrated in FIG. 10, after laser head 10 moves to the initial position, the liquid level of transmission inhibition liquid LI is adjusted to the position lower than the lower surface of workpiece WO by adjusting the liquid level of transmission inhibition liquid LI. Thus, entire workpiece WO is exposed from transmission inhibition liquid LI.

Specifically, as illustrated in FIG. 5, for example, controller 50 controls pressure reducing valve 33 to open after detecting the end of the laser processing. Thus, the amount of gas stored in liquid level adjustment tank 4 is reduced, and transmission inhibition liquid LI flows into liquid level adjustment tank 4. Therefore, the liquid level of transmission inhibition liquid LI in container 1 is lowered. At this point, controller 50 detects the liquid level of transmission inhibition liquid LI in container 1 using liquid level detection sensor 41. When determining that the liquid level of transmission inhibition liquid LI in container 1 reaches a desired liquid level, controller 50 controls pressure reducing valve 33 to be closed.

As illustrated in FIG. 13, after the liquid level of transmission inhibition liquid LI in container 1 reaches a predetermined liquid level, workpiece WO is carried out of laser processing device 20. As needed, cutting pallet 2 and sludge tray 3 are taken out of container 1. After that, sludge S in sludge tray 3 is removed.

As described above, the laser processing using laser processing device 20 of the embodiment is performed. Although the method for cutting workpiece WO has been described above as the laser processing method, the laser processing method may be a processing method such as welding using the laser beam.

In the above embodiment, it has been described that controller 50 does not start the process of adjusting the liquid level of transmission inhibition liquid LI such that entire workpiece WO sinks (is immersed) in transmission inhibition liquid LI when the transmittance of transmission inhibition liquid LI is greater than the predetermined transmittance, but the present invention is not limited thereto. When the transmittance of transmission inhibition liquid LI is greater than the predetermined transmittance, controller 50 does not need to execute the irradiation of the laser beam, and may execute the process of adjusting the liquid level of transmission inhibition liquid LI.

### <Modification>

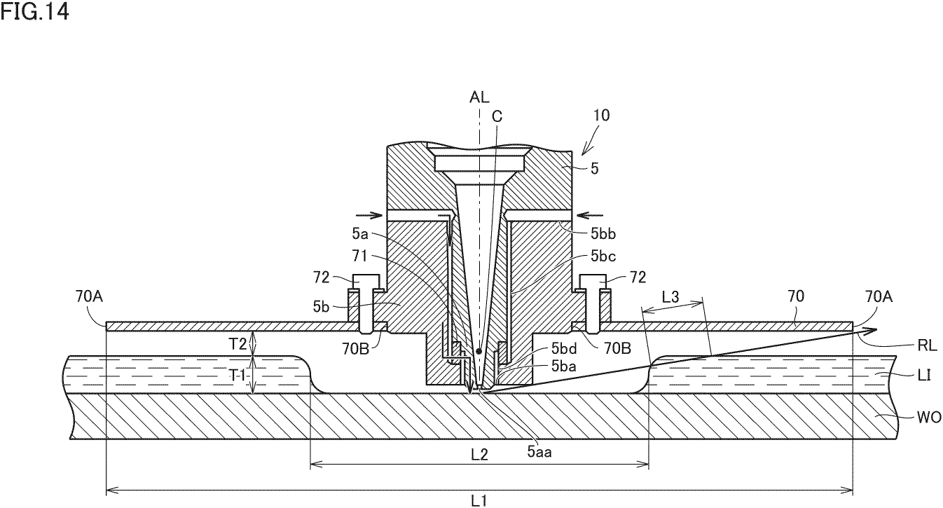

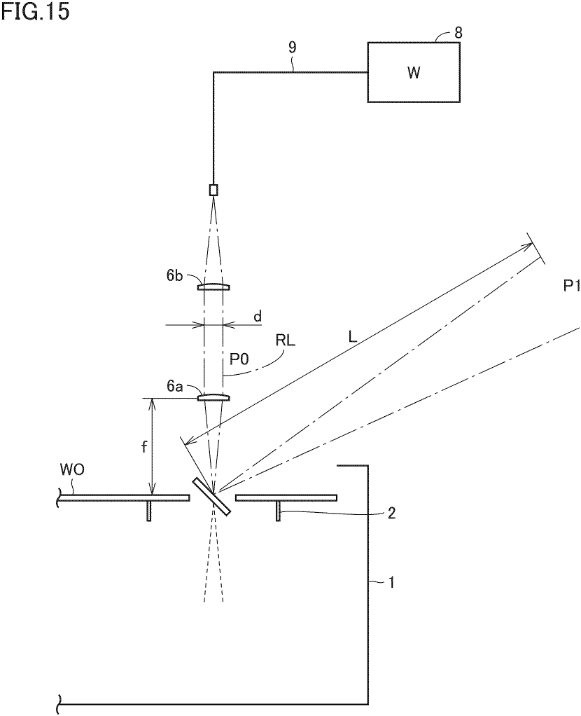

With reference to FIG. 14, modifications of the embodiment will be described below.

FIG. 14 is a sectional view illustrating another configuration of the laser beam shielding member.

In the above embodiment, as illustrated in FIG. 4, light shielding cover 7 including peripheral wall 7a, first upper plate 7b, and second upper plate 7c has been described, but the member that shields the laser beam (laser beam shielding member) is not limited to this configuration.

As illustrated in FIG. 14, the laser beam shielding member may be a plate member 70. For example, plate member 70 has an annular shape. Plate member 70 includes a lower surface opposite to workpiece WO. The lower surface of plate member 70 may have saw-tooth irregularities in a section obtained by cutting plate member 70 in the radial direction. The saw-tooth irregularities are constructed to reflect the laser beam toward the inner peripheral side of plate member 70 when the lower surface of plate member 70 is irradiated with the laser beam.

Plate member 70 may be a flat plate having a substantially constant thickness and a flat shape. When plate member 70 is the flat plate, the lower surface of plate member 70 is flat and does not have a protrusion extending from the lower surface toward workpiece WO.

Plate member 70 is attached to head body 5 by a fixing member 72 such as a bolt. Plate member 70 extends from the position where plate member 70 is attached to head body 5 onto the outer peripheral side about gas outlet 5aa in planar view. Thus, plate member 70 surrounds the periphery of laser emission port 5aa of laser head 10.

For example, plate member 70 may be made of a carbon plate or a rubber sheet. The lower surface (the surface opposite to workpiece WO) of plate member 70 may be black so as to easily absorb the laser beam. A reflector may be attached to the lower surface of plate member 70. Alternatively, a carbon sheet or a rubber sheet may be attached to the lower surface of metal plate member 70.

Plate member 70 absorbs or reflects the laser beam emitted from laser emission port 5aa of head body 5 and reflected by workpiece WO. The laser beam is absorbed by plate member 70, whereby intensity of the laser beam is reduced. In addition, the laser beam is reflected by plate member 70 and passes through transmission inhibition liquid LI, whereby the intensity of the laser beam is reduced. Thus, the leakage of the laser beam from between plate member 70 and workpiece WO is inhibited.

Furthermore, as indicated by an arrow RL in the drawing, there is the laser beam that does not hit plate member 70 but leaks to the outside from the gap between plate member 70 and workpiece WO. A dimension (diameter L1) of plate member 70 is set such that the laser beam passes through transmission inhibition liquid LI by a predetermined distance L3. When the laser beam passes through transmission inhibition liquid LI by predetermined distance L3, the intensity of the laser beam is sufficiently reduced. Thus, the leakage of the laser beam from between plate member 70 and workpiece WO is inhibited.

When the wavelength range of the laser beam is greater than or equal to 0.7 µm and less than or equal to 10 µm and when transmission inhibition liquid LI is an aqueous solution obtained by adding 0.1 volume% of the India ink to water, the intensity of the laser beam along the direction of arrow RL can be sufficiently reduced when predetermined distance L3 is greater than or equal to 10 mm. When distance T1 between the liquid level of transmission inhibition liquid LI and the upper surface of workpiece WO is 10 mm, when distance T2 between the liquid level of transmission inhibition liquid LI and the lower surface of plate member 70 is 5 mm, and when diameter L2 of transmission inhibition liquid LI that can be removed by gas is 90 mm, for example, diameter L1 of plate member 70 needs to be greater than or equal to 200 mm in order to secure predetermined distance L3 greater than or equal to 10 mm.

Plate member 70 may be slightly warped such that an outer peripheral edge 70A is positioned above or below an inner peripheral edge 70B.

Plate member 70 includes a gap space with the liquid level of transmission inhibition liquid LI. Each of the assist gas and the secondary gas blown out from head body 5 is discharged to the external space through the gap space between plate member 70 and the liquid level of transmission inhibition liquid LI.

Head body 5 is constructed such that the secondary gas forms a swirling flow and is blown out from gas outlet 5ba. The secondary gas is given a swirl component by passing through a ring 71 from gas supply unit 5bb through flow path 5bc. The secondary gas to which the swirling component is given is turned into a swirling flow and is blown out from gas outlet 5ba through flow path 5bd.

Specifically, as the secondary gas passes through ring 71, a tangential component of a circle centered on an axis AL of ring 71 is given to the flow of the secondary gas toward gas outlet 5ba. Axis AL is an imaginary straight line passing through a center C of cylindrical ring 71 and extending in the axial direction of ring 71. Thus, the secondary gas after passing through ring 71 spirally flows along the outer peripheral surface of body 5a in flow path 5bd, and is blown out from gas outlet 5ba as a swirling flow. When the secondary gas is blown out from gas outlet 5ba as the swirling flow, transmission inhibition liquid LI can be stably removed from the upper surface of workpiece WO as compared with the case where the secondary gas is blown out from gas outlet 5ba as an axial flow. For example, by making the secondary gas the swirling flow, a diameter L2 of 90 mm as illustrated in FIG. 14 can be stably obtained as a range in which transmission inhibition liquid LI can be removed from the upper surface of workpiece WO.

Instead of using the secondary gas blown out from gas outlet 5ba as the swirling flow, the gas blown out from gas outlet 5aa may be used as the swirling flow. Alternatively, both the secondary gas blown out from gas outlet 5ba and the gas blown out from gas outlet 5aa may be the swirling flow. As described above, laser head 10 is constructed such that the gas blown out from the gas outlet (outlets 5aa, 5ba) forms the swirling flow.

### Advantageous Effect of Embodiment

An advantageous effect of the embodiment will be described below.

In the embodiment, as illustrated in FIG. 12, container 1 is capable of storing transmission inhibition liquid LI up to the height position of placement unit 2c. For this reason, the laser beam processing workpiece WO placed on the placement unit 2c enters transmission inhibition liquid LI after penetrating workpiece WO. Transmission inhibition liquid LI inhibits the transmission of the laser beam. Thus, the transmission of the laser beam entering transmission inhibition liquid LI is inhibited by transmission inhibition liquid LI. Accordingly, the intensity of the laser beam is reduced in transmission inhibition liquid LI, and the leakage of the laser beam to the outside of laser processing device 20 is prevented.

In addition, the leakage of the laser beam to the outside of laser processing device 20 is prevented only by storing transmission inhibition liquid LI in container 1. Thus, the light shielding member preventing the leakage of the laser beam is not required to be installed below workpiece WO. Accordingly, the leakage of the laser beam to the outside of laser processing device 20 is prevented with a simple structure.

In addition, the leakage of the laser beam is prevented without covering entire container 1 with a machine room like the machine room-type fiber laser processing device.

Transmission inhibition liquid LI may inhibit the transmission of the light having the wavelength greater than or equal to 0.7 µm and less than or equal to 10 µm. In this case, when the laser beam having the wavelength greater than or equal to 0.7 µm and less than or equal to 10 µm is used as the laser beam, the transmission of the laser beam incident into transmission inhibition liquid LI is inhibited by transmission inhibition liquid LI. Accordingly, the intensity of the laser beam is reduced in transmission inhibition liquid LI, and the leakage of the laser beam to the outside of laser processing device 20 is prevented.

In addition, using the fiber laser as the laser beam source, power consumption in the laser processing is reduced and a life is lengthened. The light of the fiber laser easily transmits water or the like as compared with the light of the carbon dioxide laser (wavelength of 10.6 µm). However, in the embodiment, because transmission inhibition liquid LI inhibits the transmission of the light having the wavelength greater than or equal to 0.7 µm and less than or equal to 10 µm as described above, even when the fiber laser is used as the laser beam source, the laser beam is prevented from leaking out of laser processing device 20.

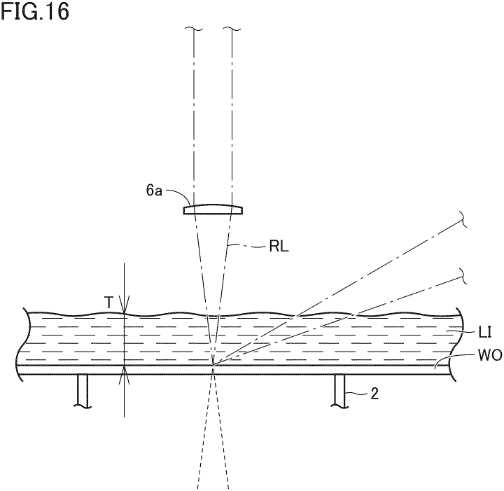

In the embodiment, the transmission inhibition liquid has the light transmittance less than or equal to 10%/cm in the wavelength range greater than or equal to 0.7 µm and less than or equal to 10 µm. In addition, the transmission inhibition liquid preferably has the light transmittance less than or equal to 5%/cm in the wavelength range greater than or equal to 0.7 µm and less than or equal to 10 µm. Furthermore, the transmission inhibition liquid more preferably has the light transmittance less than or equal to 3%/cm in the wavelength greater than or equal to 0.7 µm and less than or equal to 10 µm. With reference to FIGS. 15 to 18, the transmittances of the light beams will be described below.

FIG. 15 is a view illustrating power density of the laser beam at a distance L from the processing point of the workpiece by the laser processing. FIG. 16 is a view illustrating the thickness of the medium.

[Relationship among transmittance Q, medium thickness T, and attenuation rate δ]

An attenuation factor δ reducing the intensity of the laser beam to a level at which the surrounding is less affected even when the high-output laser beam for processing the steel sheet leaks to the outside of the laser processing device is expressed by the following expression (1) based on a Lambert-Beer law. The attenuation rate δ depends on transmittance Q and a medium distance T of a medium layer through which the scattered light or the reflected light of the laser beam passes.

$$δ = {Q}^{T}$$

Medium distance T in the expression (1) is the thickness of the medium layer attenuating the laser beam to a level at which the influence on the surroundings is small even when the laser beam leaks to the outside of the laser processing device, and the unit is cm. Transmittance Q is a ratio (= power after passing/power before passing) of power before and after the laser beam passes through the medium by 1 cm, and its unit is %/cm. Attenuation rate δ is an attenuation rate due to the laser beam passing through the medium having thickness T and transmittance Q.

In addition, level (power density) PA of the laser beam that has little influence on the surroundings even when the laser beam leaks to the outside of the apparatus is set to, for example, PA =5 mW/cm².

### Power Density of Laser Beam

As illustrated in FIG. 15, laser beam RL oscillated by a laser oscillator 8 passes through an optical fiber 9, is converted into a parallel beam by a collimator lens 6b, and is condensed on workpiece WO by condensing lens 6a.

Assuming that a laser output in laser oscillator 8 is W, the beam diameter of the parallel light is d, and the power density of the parallel light (immediately before condensing lens 6a) is P0, power density P0 of the laser beam is expressed by the following expression (2).

$$P 0 = W / π / {\left(d / 2\right)}^{2}$$

In the case of laser beam RL for processing a general steel sheet, laser output W is 3 kW, and beam diameter d of the parallel light is 2 cm. In this case, power density P0 of laser beam RL is expressed by the following expression (3) from the expression (2).

$$P 0 = 9.6 \times {10}^{5} m W / c {m}^{2}$$

### Power Density of Laser Beam at Position Distant From Processing Point

Usually, the laser beam is vertically applied to workpiece WO to form a cut groove, reaches the cutting table below workpiece WO, and attenuates while being reflected in the cutting table. At this time, depending on the state of cutting of workpiece WO, the laser beam is reflected by workpiece WO or hits a wall or a bottom plate in the cutting table to be reflected. Thus, there is a possibility that the laser beam leaks to the outside of the laser processing device.

Accordingly, as illustrated in FIG. 15, a power density P1 of laser beam RL at the position away from the processing point of workpiece WO by distance L is required to be considered. The processing point of workpiece WO corresponds to a focal position of condensing lens 6a, and the reflected light spreads conically with increasing distance from the focal position, so that the power density decreases. Assuming that f is a focal length of condensing lens 6a, power density P1 of laser beam RL at the position away from the processing point by distance L is expressed by the following expression (4).

$$P 1 = P 0 \times {\left(L / f\right)}^{- 2}$$

Assuming that the focal length f of condensing lens 6a is 15 cm, power density P1 of laser beam RL at the position away from the processing point by 60 cm is expressed by the following expressions (4) from the expression (5).

$$P 1 = 6.00 \times {10}^{4} m W / c {m}^{2}$$

Power density P1 obtained by the expression (5) has a value 10⁴ times power density PA (=5 mW/cm²). That is, unless power density P1 is attenuated to about 1/10,000 of power density PA, there is a possibility that laser beam RL leaks to the outside of the laser processing device and affects the surroundings.

### Attenuation Rate Δ Obtaining Power Density P1 Not Affecting Surrounding Of Device

When laser beam RL reflected by workpiece WO passes through a certain medium to reach the position separated by distance L, attenuation rate δ due to the medium attenuating power density P1 to the same value as power density PA is expressed by the following expression (6).

$$δ \underline{\leq } P A / P 1$$

### Relationship Between Transmittance Q and Medium Thickness T for Attenuation to Power Density PA

Here, when the transmittance of the medium is Q and when the thickness of the medium is T, a relationship of the following expression (7) is established between transmittance Q and thickness T. Thickness T of the medium is the thickness of the medium (for example, liquid LI) in the traveling direction of laser beam RL as illustrated in FIG. 16.

$$T = log δ / log Q$$

When the expressions (2), (4), (6) are substituted into attenuation factor δ in the expression (7), the following expression (8) is obtained.

$$T = log \left(P A / P 1\right) / log Q \left(= log \left(P A / \left(\left(W / π / {\left(d / 2\right)}^{2}\right)\right)\right) \times \left(L / f\right) \left({}^{- 2}\right)\right) / log Q$$

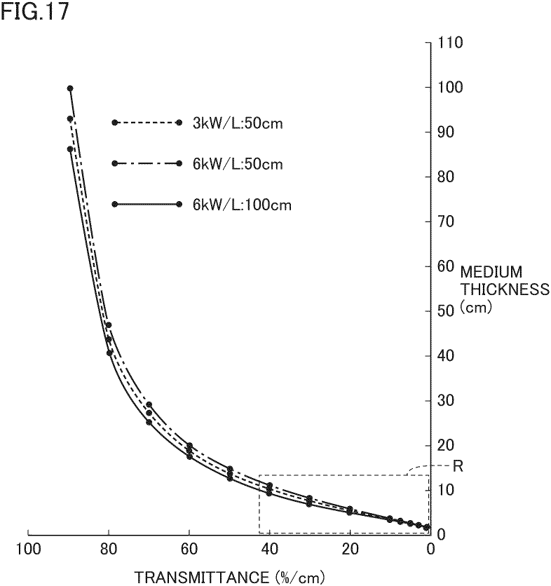

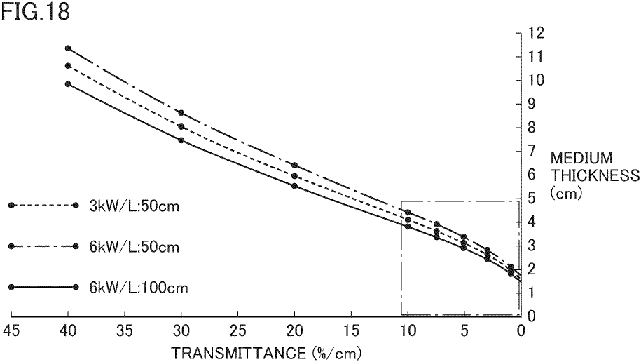

FIG. 17 is a graph illustrating the relationship between transmittance Q of the medium and thickness T of the medium when beam diameter d is 2 cm, when focal length f is 15 cm, when laser output W is 3 kW or 6 kW, and when distance L is 50 cm or 100 cm based on the expression (8). In addition, a region R in FIG. 17 is enlarged and illustrated in FIG. 18.

In FIGS. 17 and 18, a broken line indicates the case where laser output W is 3 kW while distance L is 50 cm. The alternate long and short dash line indicates the case where laser output W is 6 kW while distance L is 50 cm. A solid line indicates the case where laser output W is 6 kW while distance L is 100 cm.

At this point, as illustrated in FIG. 12, when workpiece WO is immersed in the medium, workpiece WO can be processed when thickness T of the medium on the upper surface of workpiece WO is 5 cm. From the results of FIGS. 17 and 18, it can be seen that even when the thickness of the medium is 5 cm, power density P1 at the position away from the processing point by 50 cm or 100 cm can be attenuated to power density PA by setting the transmittance of the medium less than or equal to 10 %/cm.

From the above, when the transmittance of the medium is set less than or equal to 10 %/cm, it can be seen that even when thickness T of the medium is 5 cm, power density P1 at the position away from the processing point by 60 cm can be attenuated to power density PA, and the influence on the outside of the device can be reduced. When the transmittance of the medium is set less than or equal to 5 %/cm, it can be seen that even when thickness T of the medium is 4 cm, power density P1 at the position away from the processing point by 60 cm can be attenuated to power density PA, and the influence on the outside of the device can be reduced. Furthermore, when the transmittance of the medium is set less than or equal to 3 %/cm, it can be seen that even when thickness T of the medium is 3 cm, power density P1 at the position away from the processing point by 60 cm can be attenuated to power density PA, and the influence on the outside of the device can be reduced.

In the embodiment, transmission inhibition liquid LI contains carbon as an additive inhibiting the light transmission in the wavelength range greater than or equal to 0.7 µm and less than or equal to 10 µm. By adding carbon as the additive of transmission inhibition liquid LI, the transmittance of transmission inhibition liquid LI can be significantly reduced.

In the embodiment, transmission inhibition liquid LI contains a corrosion inhibitor. This makes it possible to inhibit corrosion of workpiece WO.

In the embodiment, as illustrated in FIG. 5, the liquid level adjustment mechanism adjusts the liquid level of transmission inhibition liquid LI based on the detection result of liquid level detection sensor 41. This makes it easy to adjust the liquid level of transmission inhibition liquid LI in container 1. For this reason, workpiece WO can be immersed in transmission inhibition liquid LI during the laser processing, and workpiece WO can be exposed from transmission inhibition liquid LI when workpiece WO is carried in and out of laser processing device 20.

In the embodiment, as illustrated in FIG. 5, controller 50 issues the control instruction of at least one of the notification and the laser processing operation based on the detection result of transmittance detection sensor 42. Thus, the laser processing is performed while the transmittance of transmission inhibition liquid LI is high, so that the laser beam is prevented from leaking to the outside of laser processing device 20.

In the embodiment, as illustrated in FIG. 14, laser head 10 is constituted such that the gas blown out from the gas outlet (outlets 5aa, 5ba) forms the swirling flow. Specifically, laser head 10 is constituted such that at least one of the assist gas blown out from gas outlet 5aa and the secondary gas blown out from gas outlet 5ba forms the swirling flow. Thus, transmission inhibition liquid LI can be stably removed from the upper surface of workpiece WO as compared with the case where the gas is blown out as the axial flow from gas outlets 5aa, 5ba.

In the embodiment, the laser beam shielding member (each of light shielding cover 7 in FIG. 4 and plate member 70 in FIG. 14) surrounds the periphery of laser emission port 5aa of laser head 10. This prevents the reflected light or the scattered light of the laser beam in workpiece WO from leaking out of laser processing device 20.

In the embodiment, the lower surface of plate member 70 in FIG. 14 opposite to workpiece WO includes the sawtooth-shaped irregularities in the section obtained by cutting plate member 70 in the radial direction. Due to the saw-tooth irregularities, the laser beam applied to the lower surface of plate member 70 can be reflected toward the inner peripheral side of plate member 70. This prevents the reflected light or the scattered light of the laser beam from leaking out of laser processing device 20 with a simple configuration.

In the embodiment, as illustrated in FIG. 14, the laser beam shielding member may be plate member 70 having the lower surface opposite to workpiece WO. This prevents the reflected light or the scattered light of the laser beam from leaking out of laser processing device 20 with a simple configuration.

In the embodiment, as illustrated in FIG. 14, plate member 70 has diameter (outer diameter) L1 greater than or equal to 200 mm. This prevents the reflected light or the scattered light of the laser beam from leaking out of laser processing device 20.

In addition, in the embodiment, as illustrated in FIG. 4, second hole 7ca of light shielding cover 7 is disposed to avoid the position ahead of the laser beam that is reflected from workpiece WO, passes through first hole 7ba, and then travels linearly in gap 7d. For this reason, the laser beam reflected from workpiece WO is prevented from leaking from the inside of light shielding cover 7 to the outside. In addition, the gas can be discharged from the inside of light shielding cover 7 to the outside through first hole 7ba and second hole 7ca.

When the gas (assist gas, secondary gas) is not discharged from the inside of light shielding cover 7, the gas is discharged from the gap between light shielding cover 7 and workpiece WO, and at that time, the light shielding by transmission inhibition liquid LI is broken. In order to prevent this, first hole 7ba and second hole 7ca are provided in light shielding cover 7 in order to discharge the gas from the inside of light shielding cover 7.

In the embodiment, as illustrated in FIG. 3, laser head 10 includes gas outlets 5aa, 5ba through which the gas is blown out. Due to this gas blowing force, transmission inhibition liquid LI is pushed away at the processing point of workpiece WO. Thus, the upper surface of workpiece WO is exposed from transmission inhibition liquid LI at the processing point of workpiece WO, and the exposed processing point can be irradiated with the laser beam.

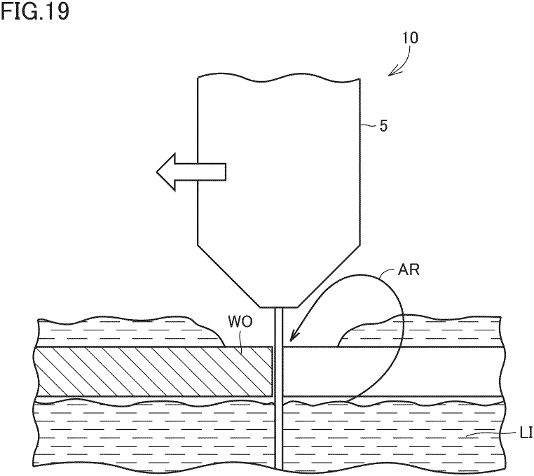

As illustrated in FIG. 19, transmission inhibition liquid LI is blown up to the upper surface side of workpiece WO through the cut groove of workpiece WO along arrow AR by the assist gas. Rolled-up transmission inhibition liquid LI is entrained in the assist gas to reach the processing point by the laser processing and the vicinity thereof, which may adversely affect the laser processing to cause a processing failure.

On the other hand, in the embodiment, as illustrated in FIG. 3, the gas outlets 5aa, 5ba include gas outlet 5aa through which the assist gas is blown out, and gas outlet 5ba disposed on the outer periphery of gas outlet 5aa. The secondary gas is blown out from gas outlet 5ba. Thus, the secondary gas prevents transmission inhibition liquid LI blown up by the assist gas from reaching the vicinity of the processing point. Therefore, transmission inhibition liquid LI wound up by the assist gas is prevented from adversely affecting the laser processing.

In PTL 1, the light shielding member attached to the lower end side of each of the laser nozzle-side cover body and the garter-side cover body comes into contact with the workpiece or the support member that supports the workpiece and bends. Because the light shielding member of PTL 1 wears by sliding with the workpiece or the support member, replacement maintenance of the light shielding member is required.

On the other hand, in the embodiment, as illustrated in FIG. 12, when workpiece WO is processed using the laser beam, the gap is provided between lower end 7L of light shielding cover 7 and workpiece WO. This prevents degradation of light shielding cover 7 due to rubbing between light shielding cover 7 and workpiece WO.

In the embodiment, as illustrated in FIG. 12, when workpiece WO is processed using the laser beam, the liquid level of transmission inhibition liquid LI is adjusted to be higher than lower end 7L of light shielding cover 7. As a result, transmission inhibition liquid LI exists in the gap between lower end 7L of light shielding cover 7 and workpiece WO. Thus, transmission inhibition liquid LI prevents the reflected light or the scattered light of the laser beam from leaking out from the gap between lower end 7L of light shielding cover 7 and workpiece WO.

In the embodiment, as illustrated in FIG. 12, workpiece WO is immersed in transmission inhibition liquid LI during the laser processing. Thus, not only the lower surface but also the upper surface of workpiece WO is cooled by the transmission inhibition liquid. Accordingly, the cooling effect of the workpiece during the laser processing is greater than that in PTLs 2 and 3.

In the embodiment, transmission inhibition liquid LI used for the laser processing inhibits the transmission of the light having the wavelength greater than or equal to 0.7 µm and less than or equal to 10 µm. Thus, when the laser beam having the wavelength greater than or equal to 0.7 µm and less than or equal to 10 µm is used as the laser beam, the laser beam incident into transmission inhibition liquid LI is inhibited by transmission inhibition liquid LI. As a result, the intensity of the laser beam is reduced in transmission inhibition liquid LI, and the leakage of the laser beam to the outside of laser processing device 20 can be prevented.

### EXAMPLE

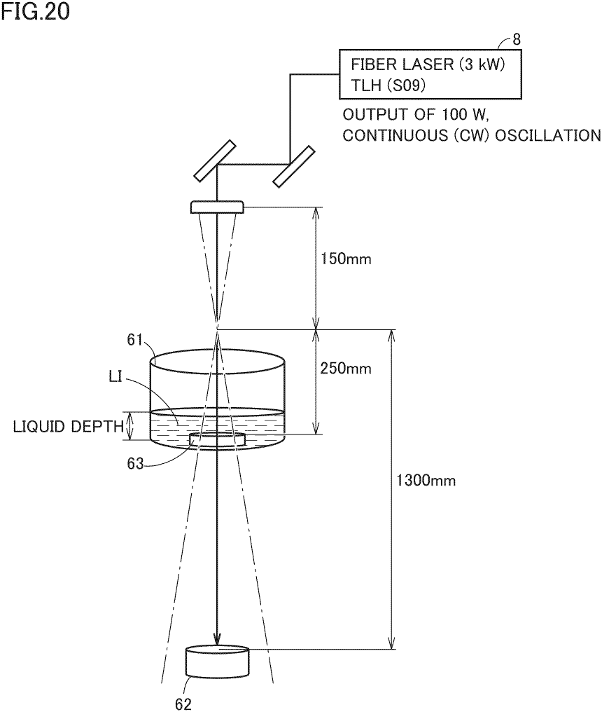

With reference to FIGS. 20 to 22, examinations conducted by the present inventors will be described below.

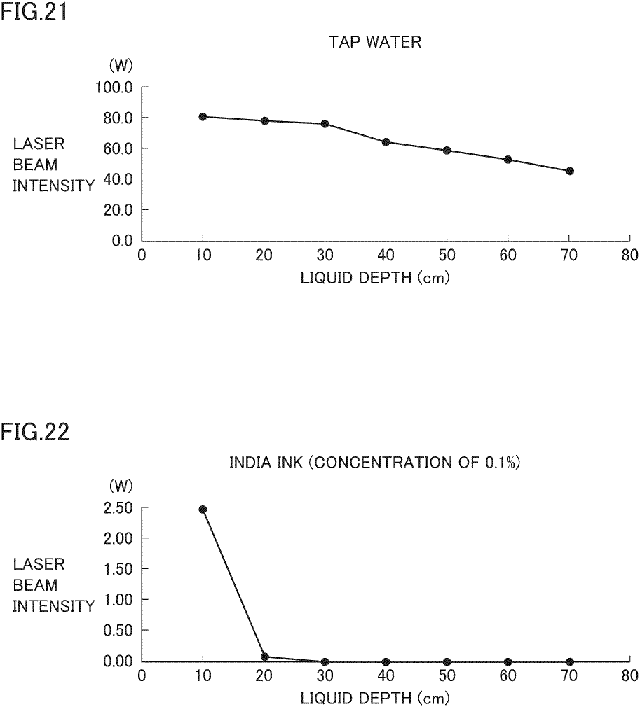

FIG. 20 is a view illustrating a configuration of a device examining a relationship between the transmittance of the laser beam and a depth of liquid. FIG. 21 is a view illustrating a relationship between intensity of the laser beam and the depth of the liquid when tap water is used. FIG. 22 is a view illustrating the relationship between the intensity of the laser beam and the depth of the liquid when the aqueous solution obtained by adding the India ink to tap water is used.

As illustrated in FIG. 20, the inventors disposed a liquid tank 61 storing the liquid in the path of the laser beam oscillated from laser oscillator 8 of the fiber laser, and the detected intensity of the transmitted light transmitted through the liquid by a sensor 62. As laser oscillator 8 of the fiber laser, an oscillator having the laser output of 3 kW was used. Using this laser oscillator 8, the laser beam was continuously oscillated at 100 W.

Synthetic quartz (φ 40 × t4) was used for a protective window 63 of liquid tank 61, and the laser beam was transmitted through protective window 63. The tap water was put into liquid tank 61, the depth of the tap water in liquid tank 61 was changed, and the intensity of the laser beam was detected by sensor 62 at each depth. The transmittance was calculated from the intensity of the detected laser beam. FIG. 21 illustrates a result of the depth of the tap water in liquid tank 61 and the intensity of the laser beam detected at each depth.

In addition, the aqueous solution obtained by adding 0.1 vol% of the India ink to the tap water was placed in liquid tank 61, the depth of the aqueous solution was changed, and the intensity of the laser beam was detected at each depth by sensor 62. The transmittance was calculated from the intensity of the detected laser beam. FIG. 22 illustrates the depth of the aqueous solution in liquid tank 61, the intensity of the laser beam detected at each depth, and the result thereof.

The India ink is formed by dispersing carbon black, namely, carbon in the aqueous solution of glue or another water-soluble resin, and the mixing ratio of the carbon black is preferably about 4.0 wt% to 20.0 wt% with respect to the total amount. Commercially available “Kuretake dark black ink BA7-18” was used as the India ink.

From the result in FIG. 21, it was found that the transmittance of the tap water was 91%/cm. From this, it was found that when the depth of the tap water was 3 cm, the intensity of the transmitted light with respect to the intensity of the incident light on the tap water was 75%. From this, it has been found that the laser beam was required to pass through the tap water having the depth of 1 m in order to set the level (power density) of the laser beam to about level PA (= 5 mW/cm²).

On the other hand, from the result in FIG. 22, it was found that the transmittance of the aqueous solution obtained by adding 0.1 vol% of the India ink to the tap water was 3%/cm. From this, it was found that when the depth of the aqueous solution was 3 cm, the intensity of the transmitted light with respect to the intensity of the incident light to the aqueous solution was 2.7×10⁻⁵%. In addition, it was also found that by passing through the aqueous solution having the depth of 3 cm, the level (power density) of the laser beam becomes 1.6 mW/cm² and becomes less than level PA (= 5 mW/cm²).

In addition, in the laser processing device of a large machine, the transmission inhibition liquid of 10 m³ (10,000 liters) is required. However, because it is sufficient that the India ink is added to the tap water at a concentration of 0.1 volume%, it is sufficient that at most about 10 liters is added to the tap water of 10 m³.

It should be considered that the disclosed embodiment and example are an example in all respects and not restrictive. The scope of the present invention is defined by not the description above, but the claims, and it is intended that all modifications within the meaning and scope equivalent to the claims are included in the present invention.

### REFERENCE SIGNS LIST

1: container, 1a: bottom wall, 1b: side wall, 1c: pallet support, 2: cutting pallet, 2a: first support plate, 2b: second support plate, 2c: placement unit, 3: sludge tray, 4: liquid level adjustment tank, 5: head body, 5a: body, 5aa, 5ba: gas outlet, 5ab, 5bb: gas supply unit, 5b: outer nozzle, 5bc, 5bd: flow path, 6a: condensing lens, 6b: collimator lens, 7: light shielding cover, 7L: lower end, 7a: peripheral wall, 7b: first upper plate, 7ba: first hole, 7c: second upper plate, 7ca: second hole, 7d: gap, 7e: internal space, 8: laser oscillator, 9: optical fiber, 10: laser head, 20: laser processing device, 21: support base, 22: X-direction movable base, 23: Y-direction movable base, 25: drive mechanism, 30: operation panel, 31: supply valve, 32: pressurizing valve, 33: pressure reducing valve, 34: discharge valve, 35: liquid storage tank, 36: supply pipe, 37: gas pipe, 38: overflow pipe, 39: liquid discharge piping, 41: liquid level detection sensor, 42: transmittance detection sensor, 50: controller, 51: alarm, 52: processing start switch, 61: liquid tank, 62: sensor, 63: protection window, 70: plate member, 70A: outer peripheral edge, 70B: inner peripheral edge, 71: O-ring, 72: fixing member, LI: transmission inhibition liquid, RL: laser beam, S: sludge, WO: workpiece

1. A laser processing device processing a workpiece using a laser beam, the laser processing device comprising:
a support member that includes a placement unit supporting a lower surface of the workpiece; and
a container that is capable of storing a transmission inhibition liquid inhibiting transmission of the laser beam up to a height position of the placement unit.

2. The laser processing device according to claim 1, wherein the transmission inhibition liquid has light transmittance less than or equal to 10%/cm in a wavelength range greater than or equal to 0.7 µm and less than or equal to 10 µm.

3. The laser processing device according to claim 1, wherein the transmission inhibition liquid has light transmittance less than or equal to 5%/cm in a wavelength range greater than or equal to 0.7 µm and less than or equal to 10 µm.

4. The laser processing device according to claim 1, wherein the transmission inhibition liquid has light transmittance less than or equal to 3%/cm in a wavelength range greater than or equal to 0.7 µm and less than or equal to 10 µm.

5. The laser processing device according to claim 1, wherein the transmission inhibition liquid contains carbon as an additive in order to inhibit transmission of light in the wavelength range greater than or equal to 0.7 µm and less than or equal to 10 µm.

6. The laser processing device according to claim 1, wherein the transmission inhibition liquid contains a corrosion inhibitor.

7. The laser processing device according to claim 1, further comprising a liquid level detection sensor that detects a liquid level of the transmission inhibition liquid stored in the container; and
a liquid level adjustment mechanism that adjusts the liquid level of the transmission inhibition liquid stored in the container based on a detection result of the liquid level detection sensor.

8. The laser processing device according to claim 1, further comprising a transmittance detection sensor that detects transmittance of the transmission inhibition liquid stored in the container; and
a controller that issues a control instruction for at least one of a notification and a laser processing operation based on a detection result of the transmittance detection sensor.

9. The laser processing device according to claim 1, further comprising a laser head that includes an emission unit that emits the laser beam; and
a laser beam shielding member that surrounds a periphery of the laser head.

10. The laser processing device according to claim 9, wherein the laser beam shielding member is a plate member including a lower surface opposite to the workpiece, and
the lower surface of the plate member includes sawtooth-shaped irregularities in a section obtained by cutting the plate member in a radial direction.

11. The laser processing device according to claim 9, wherein the laser beam shielding member is a plate member including a lower surface opposite to the workpiece.

12. The laser processing device according to claim 10, wherein the plate member has a diameter greater than or equal to 200 mm.

13. The laser processing device according to claim 9, wherein the laser beam shielding member includes:
a peripheral wall surrounding a periphery of the emission unit of the laser head, the peripheral wall having a cylindrical shape;
a first upper plate attached to the peripheral wall and provided with a first hole; and
a second upper plate attached to the peripheral wall so as to sandwich a gap on the first upper plate and provided with a second hole, and
the second hole is disposed on the second upper plate while avoiding a position ahead of a position where the laser beam reflected from the workpiece passes through the first hole and travels linearly in the gap.

14. The laser processing device according to claim 9, wherein the laser head includes a gas outlet through which gas is blown out.

15. The laser processing device according to claim 14, wherein the laser head is constituted such that the gas blown out from the gas outlet forms a swirling flow.

16. The laser processing device according to claim 14, wherein the gas outlet includes a first blow-out port that blows out an assist gas, and a second blow-out port disposed on an outer periphery of the first blow-out port.

17. The laser processing device according to of claim 1, wherein the transmission inhibition liquid absorbs light to inhibit transmission of the laser beam.

18. A laser processing method for performing laser processing on a workpiece using a laser processing device, the laser processing method comprising:
storing a transmission inhibition liquid inhibiting transmission of light having a wavelength greater than or equal to 0.7 µm and less than or equal to 10 µm in a container;
placing the workpiece on the container; and
processing the workpiece using a laser beam in a state where the transmission inhibition liquid is stored under the workpiece while the laser beam penetrating the workpiece enters the transmission inhibition liquid.

19. The laser processing method according to claim 18, wherein the laser processing device includes:
a laser head that includes an emission unit that emits the laser beam; and
a light shielding cover that surrounds a periphery of the emission unit of the laser head, and
in the processing the workpiece using the laser beam, the light shielding cover includes a gap between a lower end of the light shielding cover and the workpiece.

20. The laser processing method according to claim 19, wherein in the processing the workpiece using the laser beam, a liquid level of the transmission inhibition liquid is adjusted above the lower end of the light shielding cover.

21. A transmission inhibition liquid used for laser processing, wherein the transmission inhibition liquid inhibits transmission of light having a wavelength greater than or equal to 0.7 µm and less than or equal to 10 µm.

22. A laser processing device processing a workpiece using a laser beam, the laser processing device comprising:
a support member that includes a placement unit supporting a lower surface of the workpiece; and
a container that is capable of storing a transmission inhibition liquid inhibiting transmission of light having a wavelength greater than or equal to 0.7 µm and less than or equal to 10 µm up to a height position of the placement unit.
